(19) United States
(12) Patent Application Publication
(10) Pub. No.: US 2025/0317829 A1
(43) Pub. Date: Oct. 9, 2025

(54) COMMUNICATION ROUTING BASED ON GENERAL LOCATION AND/OR DEMOGRAPHICS

(71) Applicant: CX360, Inc., Omaha, NE (US)

(72) Inventors: Heather Daria Shanahan, Commerce, CO (US); Jeb Stuart Asuncion, Omaha, NE (US); Jeffrey J. Friesen, Omaha, NE (US); Adam Thomas Bangtson, Viroqua, WI (US); David Michael Scheet, Omaha, NE (US)

(21) Appl. No.: 19/171,602

(22) Filed: Apr. 7, 2025

Related U.S. Application Data
(60) Provisional application No. 63/631,081, filed on Apr. 8, 2024.

(51) Int. Cl. H04W 40/20; H04M 3/42

(52) U.S. Cl. CPC H04W 40/20; H04M 3/42348

(57) ABSTRACT

Particular embodiments described herein provide for a system, an apparatus, and a method to help enable communication routing based on general location and/or demographics. The system, apparatus, and method can include or enable receiving a communication from an electronic device, determining a general location of the electronic device based at least in part on data and/or metadata included with the communication, and routing the call based on the general location of the electronic device. In some examples, the system, apparatus, and method can include or enable determining demographic data related to the user the electronic device and routing the call based on the general location of the electronic device and the demographic data.

### CROSS-REFERENCE TO RELATED APPLICATIONS

This disclosure relates to Provisional Application No. 63/631,081, entitled “COMMUNICATION ROUTING BASED ON GENERAL LOCATION AND/OR DEMOGRAPHICS” filed in the United States Patent Office on Apr. 8, 2024, which is hereby incorporated by reference in its entirety.

### TECHNICAL FIELD

This disclosure relates in general to the field of computing and/or networking and, more particularly, to a system, an apparatus, and a method to help enable communication routing based on general location and/or demographics.

### BACKGROUND

Call routing is a call management process that automatically queues and distributes incoming calls based on a predefined set of rules and criteria. It is also sometimes referred to as an automatic call distribution (ACD) system. ACD is a system that automatically routes incoming calls to a specific group of agents based on predetermined criteria, such as the type of call, caller language, time of day, or caller ID. In most call centers, after a call is received, the first step in the routing process is sending the call to an interactive voice response (IVR) tool. Using IVR, the system can determine the purpose of the call through a series of automated questions and answers. The caller's responses to the IVR will then be forwarded to the ACD system for queueing. The ACD can queue inbound calls based on query, skills, or waiting time. Once the calls are queued, the next step is to have the calls routed to an agent.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a general system to help enable communication routing based on general location and/or demographics, in accordance with an embodiment of the present disclosure;

FIGS. 2A and 2B are simplified block diagrams of a general system to help enable communication routing based on general location and/or demographics, in accordance with an embodiment of the present disclosure;

FIG. 3 is a simplified block diagram of a specific implementation of a communication forwarder, in accordance with an embodiment of the present disclosure;

FIG. 4 is a simplified flowchart illustrating potential operations that may be associated with a system to help enable communication routing based on general location, in accordance with an embodiment of the present disclosure;

FIG. 5 is a simplified flowchart illustrating potential operations that may be associated with a system to help enable communication routing based on general location and additional information about the communication, in accordance with an embodiment of the present disclosure;

FIG. 6 is a simplified flowchart illustrating potential operations that may be associated with a system to help enable communication routing based on general location and additional information about the communication, in accordance with an embodiment of the present disclosure;

FIG. 7 is a simplified flowchart illustrating potential operations that may be associated with a system to help enable communication routing based on general location, in accordance with an embodiment of the present disclosure;

FIG. 8 is a simplified flowchart illustrating potential operations that may be associated with a system to help enable communication routing based on general location and/or demographics, in accordance with an embodiment of the present disclosure;

FIG. 9 is a simplified flowchart illustrating potential operations that may be associated with a system to help enable communication routing based on location, demographics, and/or additional information about the communication, in accordance with an embodiment of the present disclosure; and

FIG. 10 is a simplified flowchart illustrating potential operations that may be associated with a system to help enable communication routing based on location, demographics, and/or additional information, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, systems, means, etc. relating to enabling communication routing based on general location and/or demographics in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

In an example, a communication forwarder can offer a system, a method, and an apparatus to enable intelligent routing of communications based on a physical location of the electronic device that sent the communication. The communication can be a voice communication (e.g., a phone call), video communication, teletypewriter (TTY) communication, text communication, or other types of communication. The physical location of the electronic device (and the user of the electronic device) that sent the communication can be acquired using data and/or metadata related to the communication. The physical location of the electronic device that sent the communication only needs to be a general location (e.g., about a 10 square mile area or greater) to balance the user's need for privacy with the need for a general location of the user to allow for location based communication routing. In some examples, demographics of the user of the electronic device can be obtained and used to forward the communication to a specific communication center. In yet other examples, the physical location of the electronic device that sent the communication, demographics of the user of the electronic device, additional information provide by a user of the electronic device, and/or communication center data can be used to forward the communication to a specific communication center.

In a specific non-limiting example, a user communicates with a suicide and crisis helpline or some other helpline (e.g., customer assistance) using their mobile device over a commercial carrier network(s). Location data and/or metadata related to the user is captured by the commercial carrier networks, including but not limited to a Federal Information Processing Standards (FIPS) county code, Jurisdictional Identification Parameter (JIP), wire center identifier, rate center identifier, market area, originating carrier data, Global Positioning System (GPS) data, subscriber information, meta-data generated by the call origination device (mobile, landline, computer, and other devices), and/or latitude/longitude data. The communication passes through a series of local exchange carriers, interexchange carriers, or other communications providers. A communication forwarder receives the location data and/or metadata from the carrier and processes that the location data and/or metadata. In an example, based on the location data and/or metadata, a general location of the user can be determined and the communication can be routed or forwarded to a specific destination based on the general location of the user. In another example, specific user location data is received from the carrier (e.g., GPS data) and the specific user location data can be abstracted into a more generalized location/region to provide privacy for the user. The generalized location/region is then used to perform a routing decision to the most appropriate destination for the communication. By routing the communication at least partially based on the general location of the electronic device that initiated the communication, a user of the electronic device that initiated the communication can be connected to a call taker that is likely familiar with the environment and conditions around the user, may have a similar accent or mannerisms as the user, and/or may have similarities with the user to help the call taker establish a connection with the user and provide the help the user is seeking.

### Example Systems, Apparatuses, and Methods

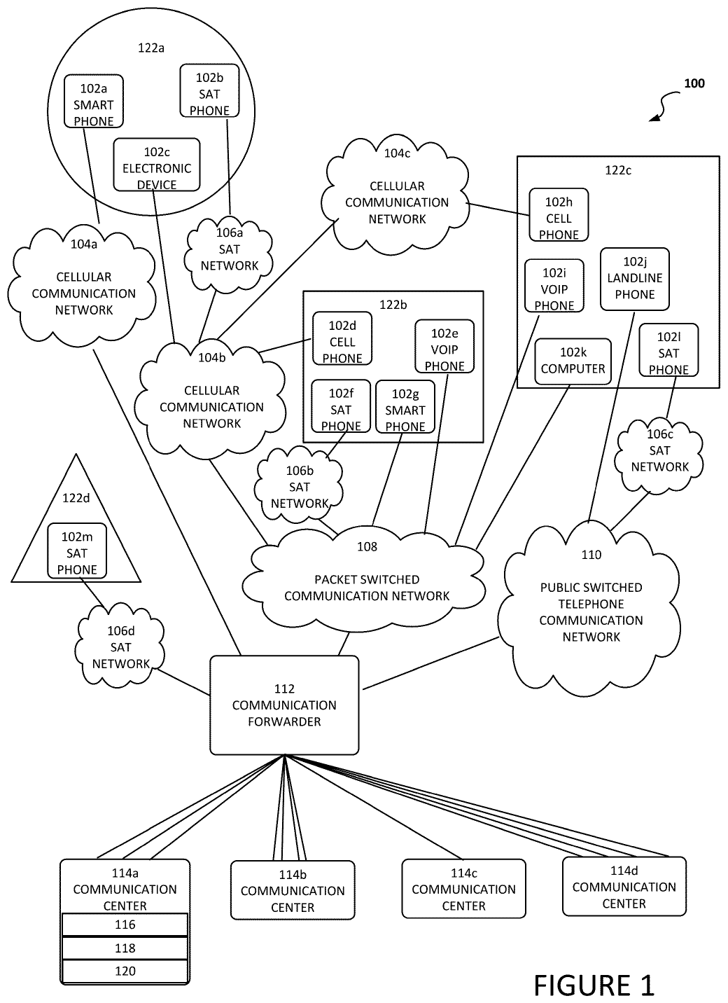

FIG. 1 is a simplified block diagram of a system 100 to help facilitate call routing. Referring to FIG. 1, in a non-limiting example, the system 100 can include one or more electronic devices 102, one or more cellular communication networks 104, one or more satellite communication networks 106, one or more packet switched networks (PSN) 108, one or more public switched telephone networks (PSTN) 110, a communication forwarder 112, and two or more communication centers 114. Each of the one or more electronic devices 102 can be a cell phone, smartphone, wireless phone, or some other wireless electronic device configured for communication over a cellular network or mobile network (e.g., cellular communication network 104), a satellite communication device or some other wireless electronic device configured for communication over a satellite communication network (e.g., satellite communication network 106), a voice over IP (VOIP) phone or some other electronic device that allows for phone calls and communication over a PSN (e.g., the PSN 108), or a landline phone or some other electronic device that allows for communications over a PSTN (e.g., PSTN 110). In some examples, the PSN 108 includes the Internet.

More specifically, in a non-limiting example illustrated in FIG. 1, the electronic devices 102a, 102d, 102g, and 102h can be cell phones or smart phones, the electronic devices 102b, 102f, 102l, and 102m can be satellite communication devices (e.g., satellite phone, satellite walkie-talkie, etc.), the electronic devices 102e and 102i can be a VOIP phone, the electronic device 102j can be a landline phone, the electronic device 102k can be a computer (e.g., a laptop computer, desktop computer, workstation, etc.), and the electronic device 102c can be a wireless communication device. In some examples, the electronic device 102c is an emergency response communication device that communicates over a public safety line (e.g., Band 14). The communication from each of the electronic devices 102a-102m can be a voice call, video call, webchat, text, or some other type of communication. In some examples, if the call is a video call, the identity of the caller is anonymized (e.g., using an avatar) to help hide the identity of the caller and protect the privacy of the caller.

In a non-limiting example illustrated in FIG. 1, the cellular communication networks 104a, 104b, and 104c can be cellular or wireless communication networks to help facilitate communications to and from the electronic devices 102a, 102c, 102d, and 102h, satellite communication networks 106a, 106b, 106c, and 106d can help facilitate communications to and from the electronic devices 102b, 102f, 102l, and 102m, the PSN 108 can be a PSN to help facilitate communications to and from the electronic devices 102c, 102e, 102g, and 102h, and the PSTN network 110e can be a PSTN to help facilitate communications to and from the electronic device 102j. In some examples, the cellular or wireless communications from the electronic devices 102a, 102c, 102d, and 102h and the satellite communications from the electronic devices 102b, 102f, 102l, and 102m are routed through the PSN 108 (e.g., the cellular or wireless communications from the electronic device 102d are routed through the cellular communication network 104b to the PSN 108). In some examples, the cellular or wireless communications from the electronic devices 102a, 102c, 102d, and 102h may be routed through one or more cellular communication networks (e.g., the cellular or wireless communications from the electronic devices 102h may be routed through the cellular communication network 104c and 104b before being routed to the PSN 108).

Each of the cellular communication networks 104a-104c, the satellite communication networks 106a-106d, the PSN 108, and the PSTN 110 can be in communication with the communication forwarder 112. More specifically, as illustrated in FIG. 1, the cellular communication network 104a, the satellite communication network 106d, the PSN 108, and the PSTN 110 are in direct communication with the communication forwarder 112, the cellular communication networks 104b and 104c and the satellite communication networks 106a and 106b are in communication with the communication forwarder 112 through the PSN 108, and the satellite communication network 106c is in communication with the communication forwarder 112 through the PSTN 110.

The communication forwarder 112 is in communication with each of the two or more communication centers 114a-114d. Each communication center 114 can be a call center, a help center, or some other type of communication center that includes one or more agents or specialists to assist users with a specific issue or problem; especially mental health issues. In some examples, one or more of the communication centers 114a-114d can include sub-groups of communication centers. For examples, as illustrated in FIG. 1, the communication center 114a includes a sub-group-116, a sub-group-118, and a sub-group-120. In some examples, each of the sub-group-116, the sub-group-118, and the sub-group-120 can include one or more agents or specialists to assist users with a specific issue or problem. More specifically, the sub-group 116 can include one or more agents or specialists to assist users with military veteran specific issues or problems, the sub-group 118 can include one or more agents or specialists to assist users with lesbian, gay, bisexual, transgender, and queer or questioning (LGBTQ) specific issues or problems, and the sub-group 120 can include one or more agents or specialists to assist users with race/ethnicity specific issues or problems. Note that each of the communications centers 114 can include one or more sub-groups.

In other examples, the sub-groups can be prioritized as primary, secondary, and tertiary. More specifically, the sub-group-116 can be a primary group, the sub-group 118 can be a secondary group, and the sub-group 120 can be a tertiary group. In some examples, each of the sub-group 116, the sub-group 118, and the sub-group 120 can be in the same physical location or one or more of the sub-group 116, the sub-group 118, and the sub-group 120 can be in a different physical location. In some examples, the sub-group 116, the sub-group 118, and the sub-group 120 can be a queue.

Each communication from the electronic devices 102a-102m can be sent to a specific communication center 114 based on a characteristic, feature, trait, or some other criteria. For example, communications from the electronic devices 102 can be forward to a specific communication center based on a general location 122 of the electronic device. In some examples, the communications from the electronic devices 102 can be forward to a specific communication center based on the phone number used to initiate the communication from the electronic device 102, a general location 122 of the electronic device 102, demographics related to the user and/or location of the electronic device, additional information provided by a user of the electronic device (e.g., through an interactive voice response (IVR) system, intelligent virtual agent (IVA), a question and response system, etc.), specific characteristics of available communication centers 114 (e.g., communication center volume, available staff, etc.), and/or the type of communication (e.g., a communication center than is equipped to handle video calls).

More specifically, in a non-limiting example, as illustrated in FIG. 1, electronic devices 102a-102c share the location 122a and communications from the electronic device devices 102a-102c can be sent to the communication center 114a. The electronic devices 102d and 102e-102g are in the same location 122b and based on being in the same location 122b, communications from the electronic devices 102d-102g can be sent to the communication center 114b. The electronic devices 102h-102l are in the same location 122c and based on being in the same location 122c, communications from the electronic devices 102h-102l can be sent to the communication center 114d. The electronic device 102m is in the location 122d and based on being in the location 122d, communications from the electronic device 102m can be sent to the communication center 114c. Note that in some examples, the communication from the electronic devices 102 can be routed based on the general location of the electronic device 102 that initiated the communication as well as demographics related to the user and/or location of the electronic device, additional information provided by a user of the electronic device, specific characteristics of available communication centers 114, and/or the type of communication. By routing the communication at least partially based on the location of the electronic device 102 that initiated the communication, a user of the electronic device that initiated the communication can be connected to an agent or call taker that is likely familiar with the environment and conditions around the user, may have a similar accent or mannerisms as the user, and/or may have similarities with the user to help the agent or call taker responding the communication establish a connection with the user and provide the help the user is seeking.

Note that the electronic devices 102a-102c are in the same location 122a, are different types of electronic devices, and the electronic devices 102a-102c use different communication networks. More specifically, the electronic device 102a is a cell phone or smart phone and communicates using the cellular communication network 104a. The electronic device 102b is a satellite communication device and communicates using the satellite communication network 106a, the cellular communication network 104b, and the PSN 108. The electronic device 102c is an electronic device and communicates using the cellular communication network 104b and the PSN 108. Also, the electronic devices 102d-102g are in the same location 122b, are different types of electronic devices, and the electronic devices 102d-102g use different communication networks. More specifically, the electronic device 102d is a cell phone or smart phone and communicates using the cellular communication network 104b and PSN 108. The electronic device 102e is a VOIP phone and communicates using the PSN 108. The electronic device 102f is a satellite communication device and communicates using the satellite communication network 106b and the PSN 108. The electronic device 120g is a smart phone and communications using the PSN 108. In addition, the electronic devices 102h-102l are in the same location 122c, are different types of electronic devices, and some use different communication networks. More specifically, the electronic device 102h is a cell phone or smart phone and communicates using the cellular communication network 104c, the cellular communication network 104b, and PSN 108. The electronic device 102i is a VOIP phone and communicates using the PSN 108. The electronic device 102j is a landline phone and communicates using the PSTN 110. The electronic device 102k is a computer and communicates using the PSN 108. The electronic device 102l is a satellite communication device and communicates using the satellite communication network 106c and the PSTN 110. The electronic device 102m is in location 112d and communicates using the satellite communication network 106d

The communication forwarder 112 is able to determine the general location of each of the electronic devices 102a-102m. In a non-limiting example, after receiving a communication from an electronic device 102, the communication forwarder 112 can analyze the communication and metadata associated with a communication to determine the physical location of the electronic device 102 that sent the communication. More specifically, the communication forwarder 112 can use one or more of a Federal Information Processing Standards (FIPS) county code, Jurisdictional Identification Parameter (JIP), wire center identifier, rate center identifier, market area, originating carrier data, GPS data, subscriber information, meta-data generated by call origination device (mobile, landline, computer, and other technologies), latitude/longitude data, and any other data and/or metadata associated with the communication to help determine a physical location of the electronic device 102 that sent the communication. In some examples, the location is a general location such as a city, zip code, county, or some other general location (e.g., a location that includes about a 5 square mile area or greater) and is not a precise location (e.g., a specific street address or a location that is accurate within 5 feet, 10 feet, or 100 feet) to respect privacy concerns of the user. By routing the communication at least partially based on the general location of the electronic device 102 that initiated the communication, a user of the electronic device that initiated the communication can be connected to an agent or a call taker that is likely familiar with the environment and conditions around the user, may have a similar accent or mannerisms as the user, and/or may have similarities with the user to help the agent or call taker establish a connection with the user and provide the help the user is seeking. In some examples, a FIPS code, is used to determine the general location of the device that initiated the communication. FIPS codes are unique, numeric identifiers assigned by the U.S. Census Bureau to geographic areas, like states and counties, and are used to identify geographic areas, such as states, counties, cities, and places.

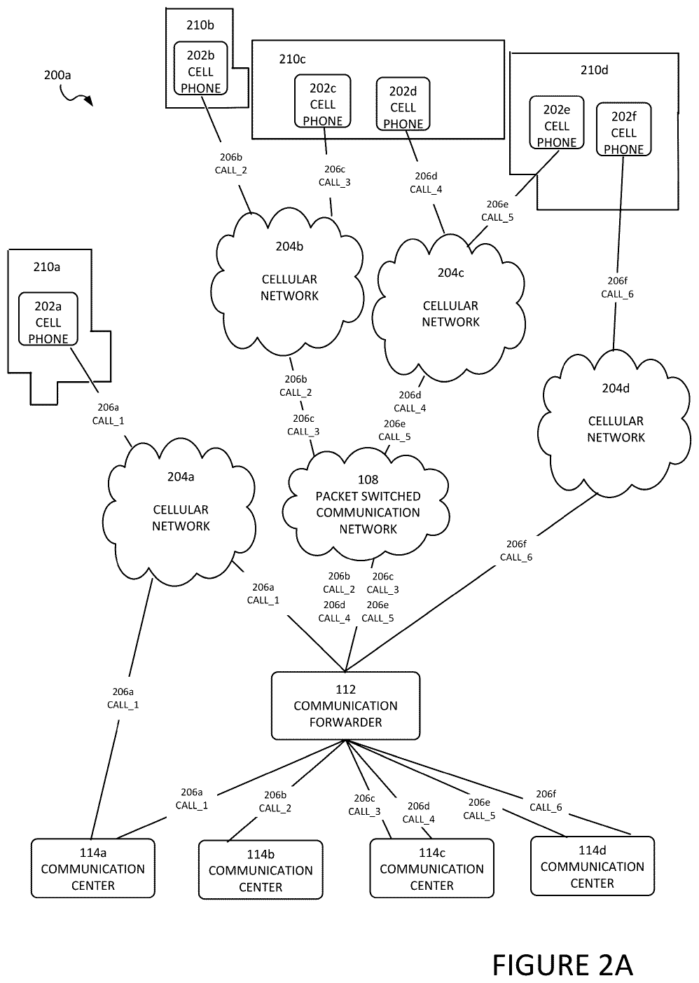

Turning to FIGS. 2A and 2B, FIGS. 2A and 2B are a simplified block diagrams of a particular non-limiting implementation of a system 200 to help facilitate call routing, in accordance with an embodiment of the present disclosure. In a non-limiting example, a system 200a, illustrated in FIG. 2A, and a system 200b, illustrated in FIG. 2B, can include one or more electronic devices 202, one or more communication networks 204, the communication forwarder 112, and two or more communication centers 114. In some examples, the system 200b illustrated in FIG. 2B can also include a location resource 214.

Referring to FIGS. 2A and 2B, each of the one or more electronic devices 202a-202f can be a cell phone, smartphone, or some other wireless electronic device configured for communication over a cellular network or mobile network. Each of the one or more communication networks 204a-204d can be a cellular or mobile communication network to help facilitate communications to and from electronic devices 202a-202f. Each of the communication networks 204a-104d can be in communication with the communication forwarder 112. The communication forwarder 112 is in communication with each of the two or more communication centers 114a-114d.

In some examples, communications from the electronic devices 102 can be sent to a same specific communication center 114 based on a common characteristic, common feature, common trait, or some other commonality shared between the electronic devices 102. In a non-limiting example, illustrated in FIGS. 2A and 2B, each of the electronic devices 202a-202f are located in a specific county 210. More specifically, the electronic device 202a can be located in county 210a, electronic device 202b can be located in county 210b, electronic devices 202c and 202d can be located in county 210c, and electronic devices 202e and 202f can be located in county 210d. Electronic device 202a can send and receive communications using a cellular or wireless communication network 204a, electronic devices 202b and 202c can send and receive communications using a cellular or wireless communication network 204b and the PSN 108, electronic devices 202d and 202e can send and receive communications using a cellular or wireless communication network 204c and the PSN 108, and electronic device 202f can send and receive communications using cellular or wireless communication network 204d.

Note that there can be various reasons why an electronic device sends and receives communications using a specific communication network including, but not limited to, proximity to the communication network and being a subscriber or customer of a specific carrier that supports the communication network. More specifically, the electronic device 202d may be closer to communication network 204b as compared to communication network 204c but the electronic device 202d may be supported by the specific carrier or wireless communication provider that is associated with the communication network 204c and not with the specific carrier or wireless communication provider that is associated with communication network 204b.

As illustrated in FIGS. 2A and 2B, communications from electronic device 202a, for example, a phone call 206a, are sent to the communication forwarder 112 using the communication network 204a. Communications from the electronic device 202b, for example, a phone call 206b, are sent to the communication forwarder 112 using the communication network 204b and the PSN 108. Communications from the electronic device 202c, for example, a phone call 206c, are sent to the communication forwarder 112 using the communication network 204b and the PSN 108. Communications from electronic device 202d, for example, a phone call 206d, are sent to the communication forwarder 112 using the communication network 204c and the PSN 108. Communications from electronic device 202e, for example, a phone call 206e, are sent to the communication forwarder 112 using the communication network 204c and the PSN 108. Communications from electronic device 202f, for example, a phone call 206f, are sent to the communication forwarder 112 using the communication network 204d.

In an illustrative example, shown in FIG. 2A, included in each of the communications 206a-206f sent by electronic devices 202a-202f respectively or in-band with the communications 206a-206f sent by electronic devices 202a-202f respectively is data and metadata (e.g., a FIPS county code, JIP, wire center identifier, rate center identifier, market area, originating carrier data, IP address, latitude/longitude data, etc.) that can be used to help determine the physical location of the electronic device 202 that sent the communication. More specifically, as illustrated in FIG. 2A, each of the electronic devices 202a-202f are located in a specific county and the communications 206a-206f from a specific electronic device 202 can include the FIPS county code that identifies the county 210 where the electronic device is physically located. The communication forwarder 112 can use the FIPS county code to help determine a physical location of the electronic device 202 that sent the communication and then forward the communication to a specific communication center.

In another illustrative example, in FIG. 2B, an out-of-band request can be used to request data and metadata (e.g., a FIPS county code, JIP, wire center identifier, rate center identifier, market area, originating carrier data, latitude/longitude data, etc.) that can be used to help determine the physical location of the electronic device 202 that sent the communication. More specifically, as illustrated in FIG. 2B, in response to receiving the phone call 206a from the electronic device 202a through the communication network 204a, the communication forwarder 112 can send an out-of-band location data request 208a to the communication network 204a, or a provider or carrier 212 of the communication network 204a for the location data of the electronic device 102a. In addition, in response to receiving the phone call 206f from the electronic device 202f through the communication network 204d, the communication forwarder 112 can send an out-of-band location data request 208a to the location resource 214 for the general location of the electronic device 202d. The location resource 214 can be a mobile carrier's location request system or some other type of system that can access the location of an electronic device 102 (e.g., the cell tower used to connect to the electronic device 102, the GPS of the electronic device 102, the location services of electronic device 102, etc.).

In some examples, demographics of the user, based on where the electronic device 202 is located and/or additional information provide by a user of the electronic device 202, can be used to forward the communication to a specific communication center 114. By routing the communication at least partially based on the location of the electronic device 202 that initiated the communication, a user of the electronic device 202 that initiated the communication can be connected to an agent or a call taker that is likely familiar with the environment and conditions around the user, may have a similar accent or mannerisms as the user, and/or may have similarities with the user to help the agent or call taker establish a connection with the user and provide the help the user is seeking.

For example, as illustrated in FIGS. 2A and 2B, the electronic devices 202e and 202f are located in the same county 210d. In an example, the physical location of the electronic device 202e and 202f can be used as the only factor when forwarding communications from the electronic devices 202e and 202f to the communication center 114d. In other examples, the location and additional factors can be used to forward the communications from the electronic devices 202. More specifically, as illustrated in FIG. 2B, the electronic device 202b is located in the county 210b and the electronic device 202c is located in the county 210c and the electronic devices 202b and 202c are not in the same county or share the same general location. The communication forwarder 112 can use the phone number used to initiate the communication (e.g., a military veteran help line number, a LBGTQ help line number, etc.), the physical location of where the electronic devices 202b and 202c are located, and/or additional information provide by a user of the electronic device 202b and a user of the electronic device 202c to forward the communications from the electronic devices 202b and 202c to the communication center 114b.

In some examples, once the communication forwarder 112 has forwarded a communication from an electronic device 202 to a specific communication center 114, further communications between the electronic device 202 and the specific communication center 114 do not pass through the communication forwarder 112. For example, as illustrated in FIG. 2A, a communication from the electronic device 202a is sent to the communication forwarder 112 using the communication network 204a. Based on the location of the electronic device 202a (e.g., in the county 210a), demographics of the user of the electronic device 202a, additional information provide by a user of the electronic device 202a, and/or communication center 114 data, the communication is forwarded to the communication center 114a. After the communication center 114a receives the communication, the communication center 114a can respond using the communication network 204a and any further communications between the electronic device 202a and the communication center 114a do not go through the communication forwarder 112.

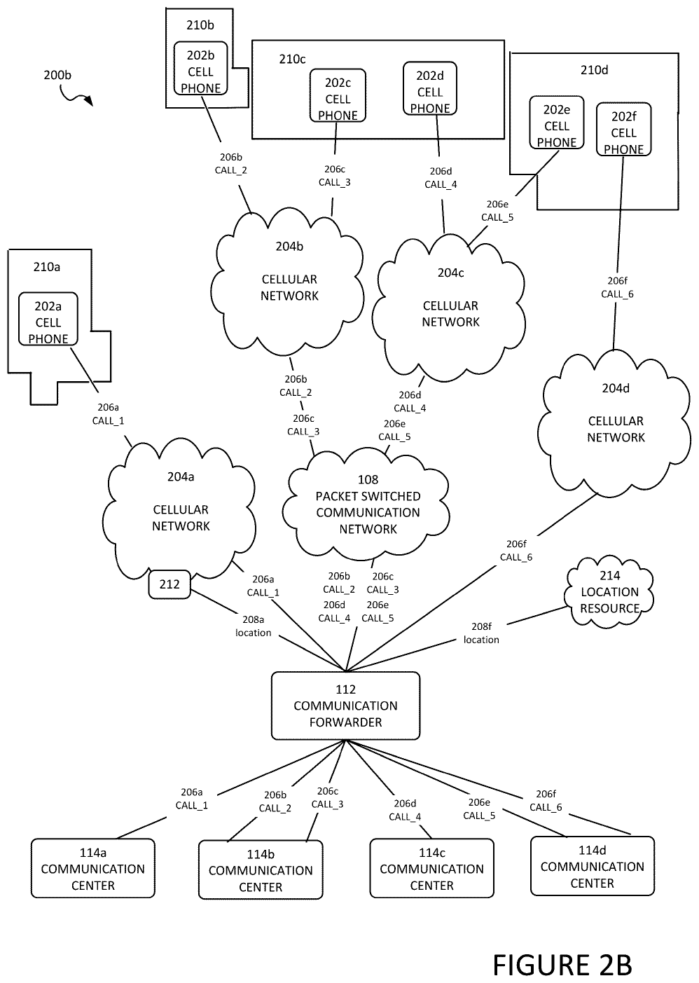

Turning to FIG. 3, FIG. 3 is a simplified block diagram of a particular non-limiting implementation of the communication forwarder 112. The communication forwarder 112 can include a location engine 302, a caller information gathering engine 304, a demographics engine 306, a communication center information gathering engine 308, and a forwarding engine 310. In some examples the communication forwarder 112 can also include one or more of a location database 312, a demographics database 314, and an information gathering database 316. In some examples, one or more of the location database 312, the demographics database 314, and the information gathering database 316 can be located outside of the communication forwarder (e.g., in a separate database). In some examples, the location database 312, the demographics database 314, and the information gathering database 316 may be combined or overlapped. Also, one or more of the location database 312, the demographics database 314, and the information gathering database 316 may be include in the same database and/or one or more of the location database 312, the demographics database 314, and the information gathering database 316 may include different tables within the same database.

The location engine 302 can be configured to use data, metadata, and/or other information related to a communication to determine a physical location of the electronic device 102 that sent the communication. In some examples, the location is a general location and not a precise location. The general location data and/or metadata can be FIPS county codes, JIP, wire center identifier, rate center identifier, market area, originating carrier data, GPS data, subscriber information, latitude/longitude data, and other data and/or meta-data generated by the call origination device. The caller information gathering engine 304 can be configured to communicate with a user of the electronic device that sent the communication to determine additional details related to the communication. The communication with the user may be a question-and-answer type communication where the user is prompted to answer questions related to the communication. The answers may be in the form of prompts to say “Yes” or “No” to specific questions or press “1” on a smartphone for “yes” or press “2” on the smartphone for “no” to specific questions. In some examples, a script (e.g., from the information gathering database 316) is used to help determine additional details related to the communication. The caller information gathering engine 304 can include an IVR or IVA tool or computerized agent that can respond to prompts and collect information.

The demographics engine 306 can be configured to determine demographics related to the user of the electronic device 102 that originated the communication. The determined demographics can be based on data from the location engine 302 (e.g., if the user is calling from an Indian Reservation, if the user is calling from an area where a natural disaster has occurred such as a hurricane, earthquake, etc. or some other area), information gathered by the caller information gathering engine 304, and/or the phone number used to initiate the communication (e.g., a military veteran help line).

The communication center information gathering engine 308 can be configured to communicate with the communication centers 114 to determine details related to each communication center 114. More specifically, the communication center information gathering engine 308 can be configured to determine call volume at each communication center 114, available staff at each communication center 114, call wait times at each communication center 114, etc.

The forwarding engine 310 can be configured to use the location determined from the location engine 302, additional information obtained from the caller information gathering engine 304, demographics determined by the demographics engine 306, and/or information obtained from the communication center information gathering engine 308 to selected a specific communication center to forward the communication. In addition to the communication, the forwarding engine 310 can also communicate the determined location, determined demographics, and/or any additional information or details related to the communication to the communication center 114 for additional routing of the communication and/or to make the information available to a communication center operator (e.g., agent or call taker).

The location database 312 can include FIPS county codes, JIP, wire center identifiers, rate center identifiers, market areas, originating carrier data, latitudes/longitudes, or any other data, tables, charts, graphs, etc. that can be used by the location engine 302 to determine a physical location of the electronic device that sent the communication. The demographics database 314 can include demographics for specific phone numbers used to initiate the communication. The information gathering database 316 can include scripts, questions, or any other type of information or data that may be used by the caller information gathering engine 304 to help the caller information gathering engine 304 communicate with a user of the electronic device that sent the communication to determine additional details related to the communication.

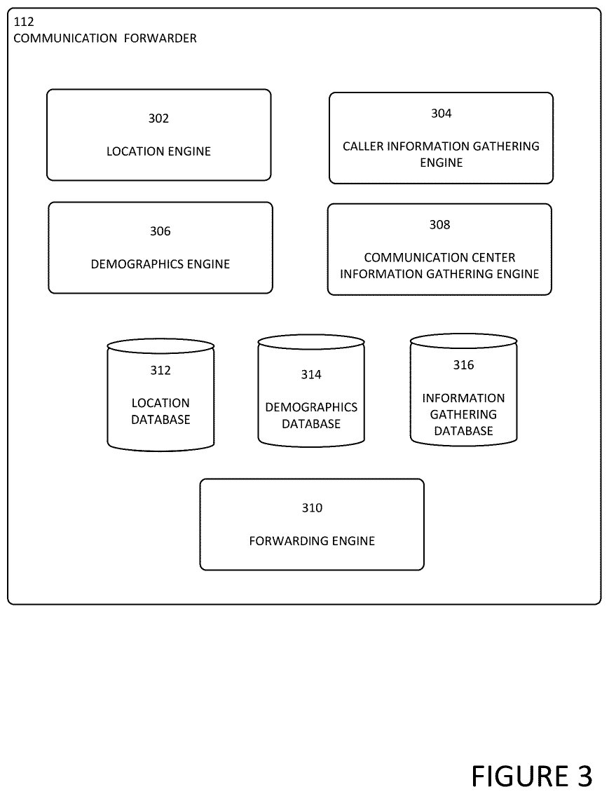

Turning to FIG. 4, FIG. 4 is an example flowchart illustrating possible operations of a flow 400 that may be associated with a system, an apparatus, and a method to help enable communication routing based on general location and/or demographics. In some examples, one or more operations of flow 400 may be performed by the communication forwarder 112, the location engine 302, the caller information gathering engine 304, the demographics engine 306, and/or the forwarding engine 310. At 402, a communication associated with a phone number is received. At 404, they systems determines if a physical location of where the communication originated can be determined. If the physical location of where the communication originated can be determined, the communication is routed to a communication center based on the determined physical location, as in 406. If the physical location cannot be determined, the communication is routed to a communication center based on the area code of the phone number associated with the communication, as in 408. In some examples, the communication forwarder 112 can include a legacy call forwarder that uses the NPA-NXX numbering plan where “NPA” represents the numbering plan area, which is the area code for a telephone number and “NXX” represents to the first three digits of a telephone number, that identifies the specific telephone company central office that serves that number.

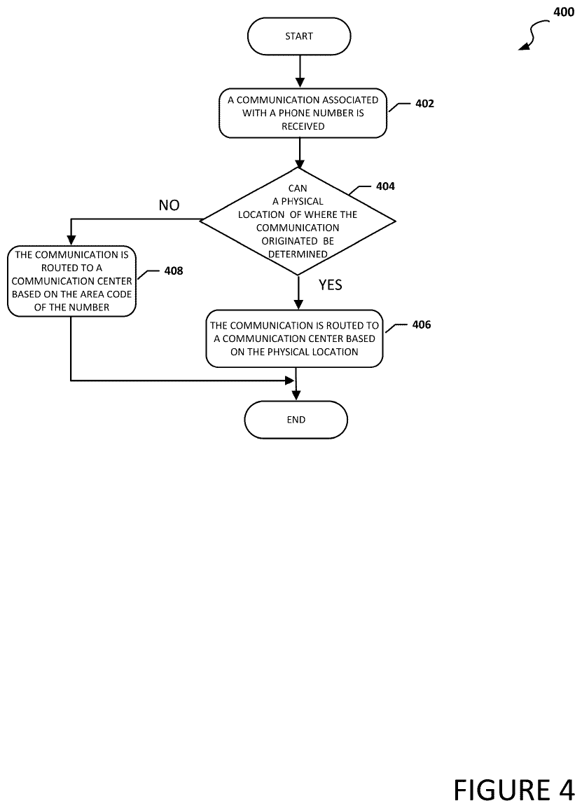

Turning to FIG. 5, FIG. 5 is an example flowchart illustrating possible operations of a flow 500 that may be associated with a system, an apparatus, and a method to help enable communication routing based on general location and/or demographics. In some examples, one or more operations of flow 500 may be performed by the communication forwarder 112, the location engine 302, the caller information gathering engine 304, the demographics engine 306, and/or the forwarding engine 310. At 502, a communication using an N11 Code is initiated. The N11 Code is a three-digit dialing code used in abbreviated dialing in the North American Numbering Plan (NANP). At 504, the system determines if a physical location of where the communication originated can be determined. If the physical location of where the communication originated can be determined, the communication is routed to a communication center based on the determined physical location and the N11 Code used to initiate the communication, as in 506. If the physical location cannot be determined, the communication is routed to a communication center based on the N11 Code used to initiate the communication, as in 508.

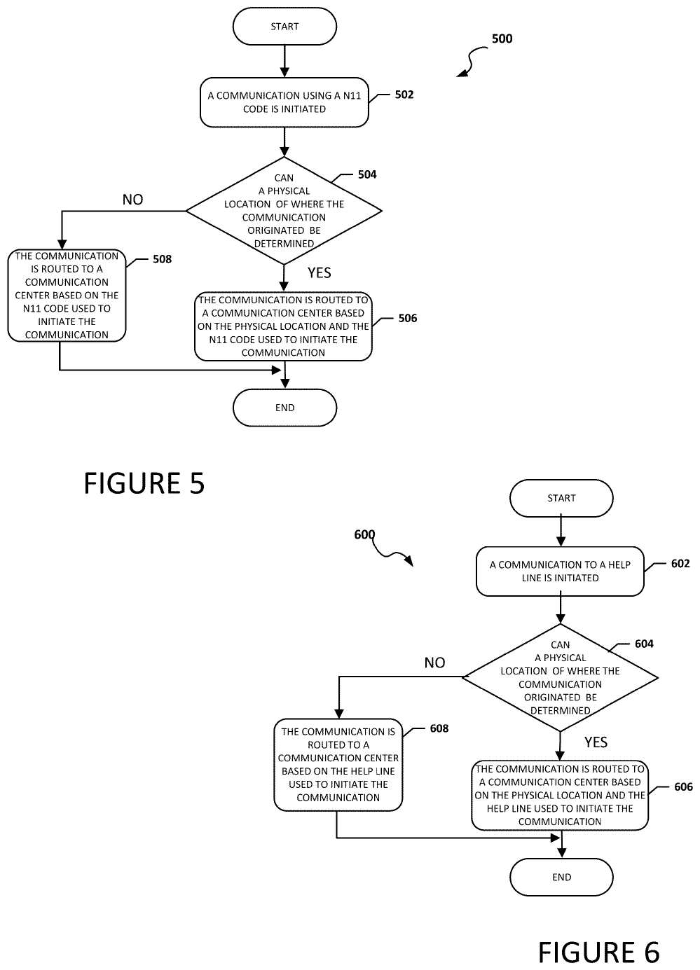

Turning to FIG. 6, FIG. 6 is an example flowchart illustrating possible operations of a flow 600 that may be associated with a system, an apparatus, and a method to help enable communication routing based on general location and/or demographics. In some examples, one or more operations of flow 600 may be performed by the communication forwarder 112, the location engine 302, the caller information gathering engine 304, the demographics engine 306, and/or the forwarding engine 310. At 602, a communication to a help line is initiated. For example, the communication may be from a user seeking help with a mental health issue. At 604, the system determines if a physical location of where the communication originated can be determined. If the physical location of where the communication originated can be determined, the communication is routed to a communication center based on the determined physical location and the help line that was used to initiate the communication, as in 606. If the physical location of where the communication originated cannot be determined, the communication is routed to a communication center based on the help line that was used to initiate the communication, as in 608.

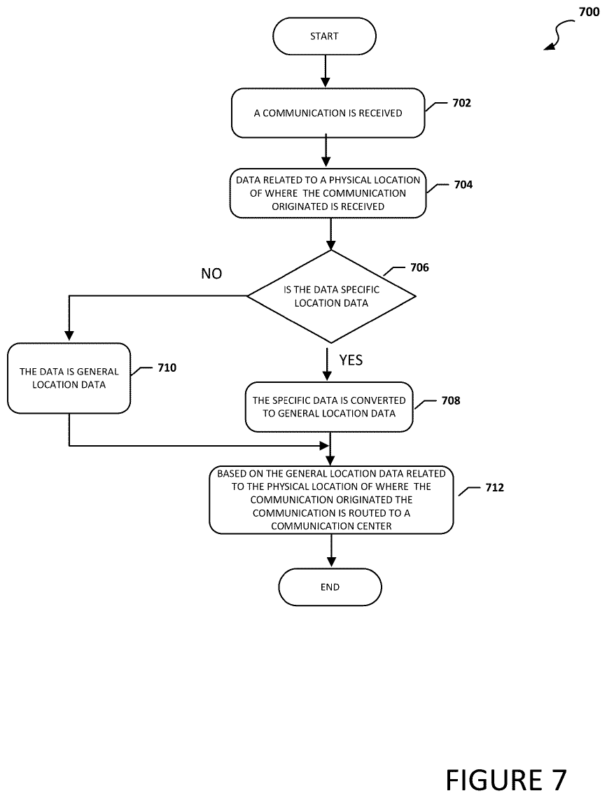

Turning to FIG. 7, FIG. 7 is an example flowchart illustrating possible operations of a flow 700 that may be associated with a system, an apparatus, and a method to help enable communication routing based on general location and/or demographics. In some examples, one or more operations of flow 700 may be performed by the communication forwarder 112, the location engine 302, the caller information gathering engine 304, the demographics engine 306, and/or the forwarding engine 310. At 702, a communication is received. At 704, data related to a physical location of where the communication originated is received. At 706, the system determines if the data is specific location data. For example, if the data is a street address or some other type of data that can identify the physical location of the user to within 100 feet or less, then the data is specific location data. If the data is specific location data, the data is converted to general location data, as in 708. The general location data is location data that gives a general location, such as a county, zip code, town, city, etc. If the data is not specific location data, then the data is general location data, as in 710. At 712, based on the general location data related to the physical location of where the communication originated, the communication is routed to a communication center.

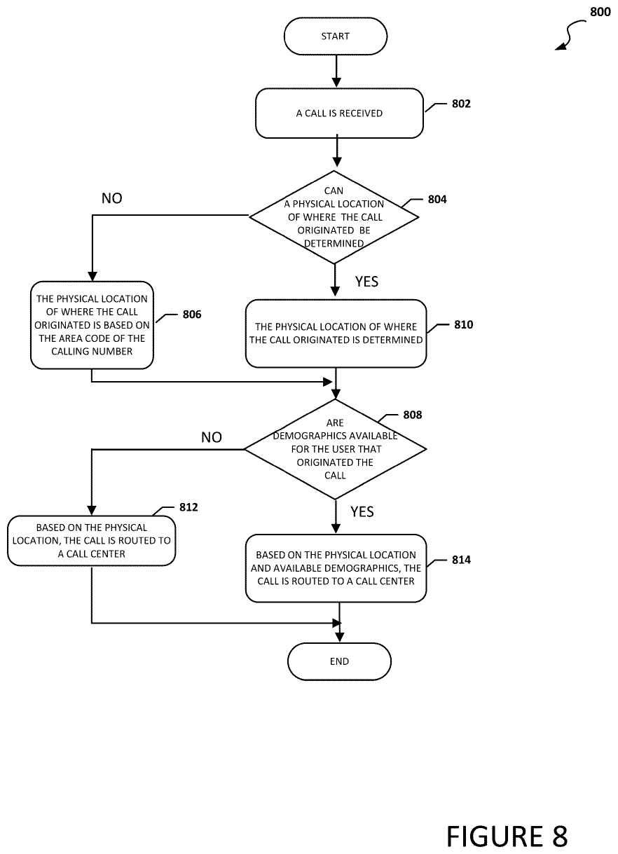

Turning to FIG. 8, FIG. 8 is an example flowchart illustrating possible operations of a flow 800 that may be associated with a system, an apparatus, and a method to help enable communication routing based on general location and/or demographics. In some examples, one or more operations of flow 800 may be performed by the communication forwarder 112, the location engine 302, the caller information gathering engine 304, the demographics engine 306, and/or the forwarding engine 310. At 802, a call is received. At 804, the system determines if a physical location of where the call originated can be determined. If the physical location of where the call originated cannot be determined, the physical location of where the call originated is based on the area code of the calling number, as in 806. If the physical location of where the call originated can be determined, then the physical location of where the call originated is determined, as in 810. For example, the location of where the call originated can be determined by FIPS county codes, JIP, wire center identifiers, rate center identifiers, market areas, originating carrier data, GPS data, subscriber information, latitude/longitude data, or any other data, metadata, tables, charts, graphs, etc. that can be used by the location engine 302 to determine a physical location of the electronic device that initiated the call.

At 808, the system determines if demographics are available for the user that originated the call. For example, the demographics engine 306 can determine demographics of the user that originated the call based on data from the location engine 302, information gathered by the caller information gathering engine 304, and/or the phone number used to initiate the call. If demographics are available for the user that originated the call, the call is routed to a communication center based on the physical location of the electronic device that originated the call and available demographics, as in 814. If demographics are not available for the user that originated the call, the call is routed to a communication center based on the physical location of the electronic device that originated the call, as in 812.

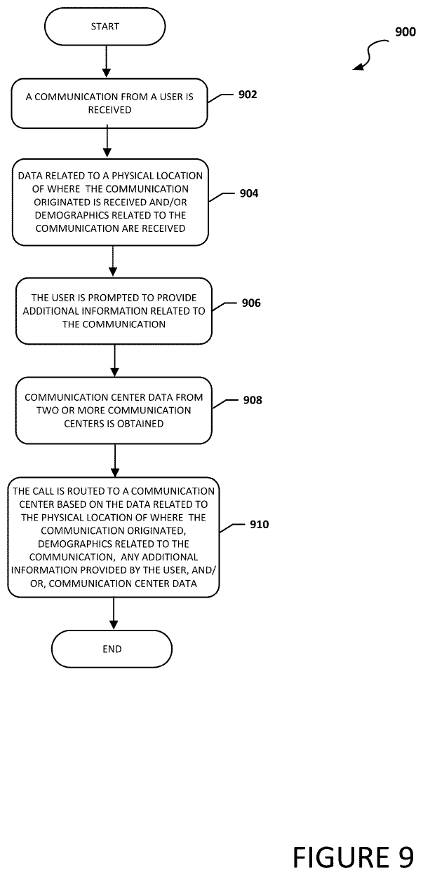

Turning to FIG. 9, FIG. 9 is an example flowchart illustrating possible operations of a flow 900 that may be associated with a system, an apparatus, and a method to help enable communication routing based on general location and/or demographics. In some examples, one or more operations of flow 900 may be performed by the communication forwarder 112, the location engine 302, the caller information gathering engine 304, the demographics engine 306, and/or the forwarding engine 310. At 902, a communication from a user is received. At 904, data related to a physical location of where the communication originated is received and/or demographics related to the communication are received. At 906, the user is prompted to provide additional information related to the communication. At 908, communication center data from two or more communication centers is obtained. At 910, the call is routed to a communication center based on the data related to the physical location of where the communication originated, demographics related to the communication, any additional information provided by the user, and/or communication center data from two or more communication centers.

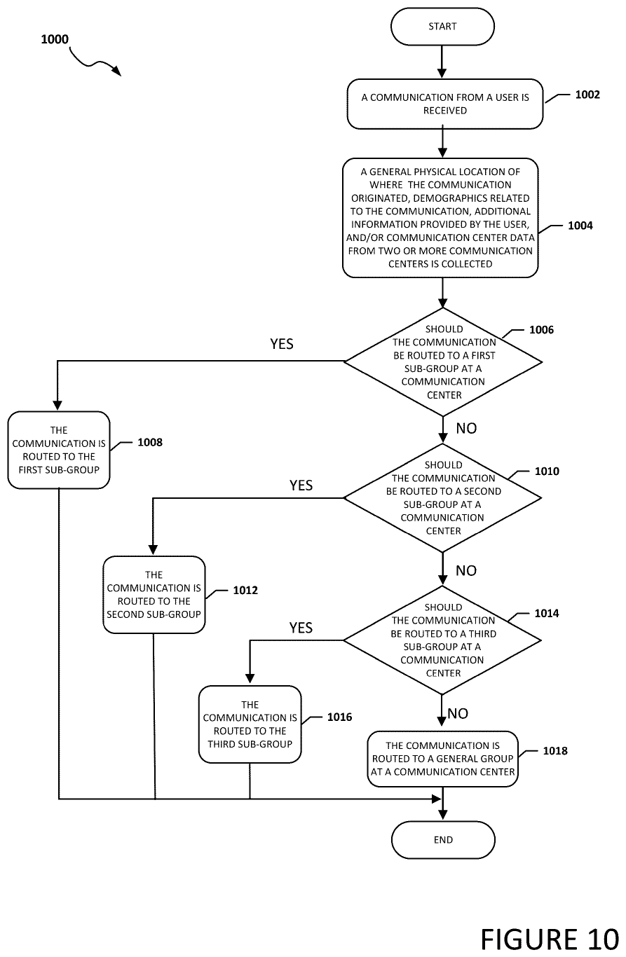

Turning to FIG. 10, FIG. 10 is an example flowchart illustrating possible operations of a flow 1000 that may be associated with a system, an apparatus, and a method to help enable communication routing based on general location and/or demographics. In some examples, one or more operations of flow 1000 may be performed by the communication forwarder 112, the location engine 302, the caller information gathering engine 304, the demographics engine 306, and/or the forwarding engine 310. At 1002, a communication from a user is received. At 1004, a general physical location of where the communication originated, demographics related to the communication, any additional information provided by the user, and/or communication center data from two or more communication centers is collected. At 1006, based on the general physical location of where the communication originated, demographics related to the communication, any additional information provided by the user, and/or communication center data from two or more communication centers, the system determines if the communication should be routed to a first sub-group at a communication center. If the communication should be routed to the first sub-group at the communication center, the communication is routed to the first sub-group at the communication center, as in 1008. For example, the first sub-group (e.g., sub-group 116) may be a military veteran sub-group where the user that originated the communication can obtain help specific to military veterans.

If the communication should not be routed to the first sub-group at the communication center, based on the general physical location of where the communication originated, demographics related to the communication, any additional information provided by the user, and/or communication center data from two or more communication centers, the system determines if the communication should be routed to a second sub-group at a communication center, as in 1010. If the communication should be routed to the second sub-group at the communication center, the communication is routed to the second sub-group at the communication center, as in 1012. For example, the second sub-group (e.g., sub-group 118) may be an LGBTQ sub-group where the user that originated the communication can obtain help specific to LGBTQ issues.

If the communication should not be routed to the second sub-group at the communication center, based on the general physical location of where the communication originated, demographics related to the communication, any additional information provided by the user, and/or communication center data from two or more communication centers, the system determines if the communication should be routed to a third sub-group at a communication center, as in 1014. If the communication should be routed to the third sub-group at the communication center, the communication is routed to the third sub-group at the communication center, as in 1016. For example, the third sub-group (e.g., sub-group 120) may be a specific ethnic sub-group where the user that originated the communication can obtain help specific to the ethnicity of the user that originated the communication. If the communication should not be routed to the third sub-group at the communication center, the communication is routed to a general group at a communication center, as in 1018. Note that the system can include fewer or more sub-groups than three sub-groups.

Note that embodiments of the electronic devices 102a-102m, the communication forwarder 112, and the communication centers 114 each include suitable interfaces for receiving, transmitting, and/or otherwise communicating data or information in a network environment. Each of the electronic devices 102a-102m, the communication forwarder 112, and the communication centers 114 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces may include physical ports (e.g., Ethernet, USB, HDMI, etc.), interfaces for wired and wireless internal subsystems, and the like.

In an example implementation, while a specific type of device is given for each of the electronic device 102a-102m, the electronic devices 102a-102m are meant to encompass a computer, a personal digital assistant (PDA), a laptop or electronic notebook, hand held device, a cellular telephone, a smartphone, an IP phone, wearables, satellite communication device, network elements, Internet of Things (IOT) devices, or any other device, component, element, or object that is enabled to communicate with a communication center over a device supported communication network; especially communications that are related to mental health.

Each of the electronic devices 102a-102m, the communication forwarder 112, the communication centers 114, and other associated or integrated components (e.g., the location engine 302, the caller information gathering engine 304, the demographics engine 306, the communication center information gathering engine 308, and the forwarding engine 310) may include any suitable hardware, software, components, modules, or objects that facilitate the operations discussed herein, as well as suitable interfaces for receiving, transmitting, and/or otherwise communicating data or information in a network environment. This may be inclusive of appropriate algorithms and communication protocols that allow for the effective exchange of data or information. Each of the electronic devices the electronic devices 102a-102m, the communication forwarder 112, the communication centers 114, and other associated or integrated components may include virtual elements.

Each of the electronic devices 102a-102m, the communication forwarder 112, the communication centers 114, and other associated or integrated components can include one or more memory elements having software and/or hardware for storing information to be used in achieving operations associated with enabling communication routing based on general location and/or demographics, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the electronic devices 102a-102m, the communication forwarder 112, and the communication centers 114 could be provided in any database, register, table, cache, queue, control list, or storage structure, based on particular needs and implementations, all of which could be referenced in any suitable time frame. Any of the memory or storage options discussed herein should be construed as being encompassed within the broad term ‘memory element’ as used herein in this Specification.

In example embodiments, the operations for enabling communication routing based on general location and/or demographics, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the communication routing activities described in this Specification.

Regarding a physical implementation of the electronic devices 102a-102m, the communication forwarder 112, the communication centers 114, and associated components such as the location engine 302, the caller information gathering engine 304, the demographics engine 306, the communication center information gathering engine 308, the forwarding engine 310, etc., any suitable permutation may be assembled or otherwise provisioned based on particular needs and requirements. In one embodiment, the location engine 302, the caller information gathering engine 304, the demographics engine 306, the communication center information gathering engine 308, and/or the forwarding engine 310 may be integrated with the communication forwarder 112, and therefore share hardware resources such as the processors and the memory. Alternatively, the location engine 302, the caller information gathering engine 304, the demographics engine 306, the communication center information gathering engine 308, and/or the forwarding engine 310 may be implemented separately, including being provisioned as a stand-alone device. In this alternative implementation, the caller information gathering engine 304, the location engine 302, the demographics engine 306, the communication center information gathering engine 308, and/or the forwarding engine 310 may be provided with separate hardware resources including one or more processors and memory elements.

In an example implementation, elements of the electronic devices 102a-102m, the communication forwarded 112, the location engine 302, the caller information gathering engine 304, the demographics engine 306, the communication center information gathering engine 308, and the forwarding engine 310 may include software modules to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of the electronic devices 102a-102m and the communication forwarder 112 can include one or more processors that can execute software or an algorithm. In one example, the processors could transform an element or an article (e.g., data) from one state or thing to another state or thing. In another example, activities may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

In the above description, various aspects of the illustrative implementations are be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the above detailed description, reference is made to the accompanying drawings that form a part hereof wherein numerals designate like parts throughout, and in which is shown, by way of illustration, embodiments that may be practiced. It is to be understood that other embodiments may be utilized, and structural or logical changes may be made without departing from the scope of the present disclosure. Therefore, the above detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. Substantial flexibility is provided by the architecture to help enable communication routing based on general location and/or demographics in that any suitable arrangements, chronologies, configurations, and timing mechanisms may be provided without departing from the teachings of the present disclosure.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the architecture to enable communication routing based on general location and/or demographics and its teachings are readily scalable and can accommodate a large number of components, as well as more complicated/sophisticated arrangements and configurations. Accordingly, the examples provided should not limit the scope or inhibit the broad teachings of the architecture to help enable communication routing based on general location and/or demographics and as potentially applied to a myriad of other architectures.

It is also important to note that the operations in the preceding flow diagrams (i.e., FIGS. 4-10) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving, at a communication forwarder, from an electronic device, a communication related to mental health of a user of the electronic device;
determining a general location of the electronic device based at least in part on data and/or metadata included with the communication;
determining demographic data related to the user of the electronic device; and
routing the communication to a communication center based on the general location of the electronic device and the determined demographic data.

2. The method of claim 1, further comprising:
determining data related to a plurality of communication centers; and
routing the communication based on the general location of the electronic device, the determined demographic data, and the data related to the plurality of communication centers.

3. The method of claim 1, wherein the communication is a phone call and the general location is based on a Federal Information Processing Standards (FIPS) county code associated with the communication.

4. The method of claim 1, wherein at least a portion of the demographic data is determined by a phone number used to initiate the communication.

5. The method of claim 1, wherein the communication center includes at least one sub-group that is related to the demographic data.

6. The method of claim 1, wherein the general location is about a 5 square mile area or more.

7. A system, comprising:
memory;
at least one processor; and
a communication forwarder configured to:
receive a voice call from an electronic device;
determine a general location of the electronic device based at least in part on metadata included with the voice call; and
rout the voice call to a communication center based on the general location of the electronic device.

8. The system of claim 7, wherein the communication forwarder is further configured to:
determine demographic data related to a user that initiated the voice call from the electronic device; and
route the voice call based on the general location of the electronic device and the demographic data.

9. The system of claim 8, wherein at least a portion of the demographic data is determined by a phone number used by the user to initiate the voice call.

10. The system of claim 7, wherein the voice call is initiated by a user of the electronic device to seek mental health help.

11. The system of claim 7, wherein the communication forwarder is further configured to:
determine data related to a plurality of communication centers; and
route the voice call based on the general location of the electronic device and the data related to the plurality of communication centers.

12. The system of claim 7, wherein the voice call is a call from a cell phone, smartphone, or wireless phone and the general location is based on a Federal Information Processing Standards (FIPS) county code associated with the communication.

13. A method for routing communications, the method comprising:
receiving a phone call from an electronic device;
determining a general location of the electronic device based at least in part on metadata included with the phone call; and
routing the phone call based on the general location of the electronic device.

14. The method of claim 13, further comprising:
determining demographic data related to a user that initiated the phone call from the electronic device; and
routing the phone call based on the general location of the electronic device and the demographic data.

15. The method of claim 14, wherein at least a portion of the demographic data is determined by a phone number used by the user to initiate the phone call.

13. The method of claim 13, wherein the phone call is initiated by a user of the electronic device to seek mental health help.

13. The method of claim 13, further comprising:
determining data related to a plurality of communication centers; and
routing the phone call based on the general location of the electronic device and the data related to the plurality of communication centers.

18. The method of claim 13, wherein the phone call is from a cell phone, smartphone, or wireless phone and the general location is based on a Federal Information Processing Standards (FIPS) county code associated with the phone call.

19. The method of claim 13, further comprising:
receiving specific location data or metadata for the electronic device; and
converting the specific location data or metadata into general location data or metadata for the electronic device.

20. The method of claim 13, wherein the general location is greater than about a five (5) square mile area.
